(19) United States
(12) Patent Application Publication
(10) Pub. No.: US 2009/0120087 A1
(43) Pub. Date: May 14, 2009

(54) Exhaust gas turbocharger in an internal combustion engine

(76) Inventors: Siegfried Sumser, Stuttgart (DE); Wolfram Schmid, Nurtingen (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/288,959

(22) Filed: Oct. 24, 2008

Related U.S. Application Data
(63) Continuation-in-part of application No. PCT/EP2007/003085, filed on Apr. 5, 2007.

(30) Foreign Application Priority Data
Apr. 28, 2006 (DE) 10 2006 019 780.1

(51) Int. Cl. F02D 23/00

(52) U.S. Cl. 60/600

(57) ABSTRACT

In an exhaust-gas turbocharger of an internal combustion engine including an exhaust-gas turbine coupled to a compressor by a shaft and having a relatively large and a relatively small turbine inlet flow passage, the relatively large turbine inlet flow passage is arranged adjacent to the shaft and the relatively small turbine inlet flow passage facing away from the shaft and a switching device is provided via which the exhaust gas of the cylinders can be selectively supplied either to the small or to the large or to both of turbine inlet flow passages and furthermore, an exhaust gas recirculation line connected to the exhaust gas line leading to the small turbine inlet flow passage is in communication with the engine intake tract.

This is a Continuation-in-Part application of pending international patent application PCT/EP2007/003085 filed 5/Apr./2007 and claiming the priority of German patent application 10 2006 019 780.1 filed Apr. 28, 2006.

### BACKGROUND OF THE INVENTION

The invention relates to an exhaust-gas turbocharger in an internal combustion engine with an exhaust gas turbine having two turbine inlet passages.

DE 103 57 925 A1 discloses a supercharged internal combustion engine with an exhaust-gas turbocharger which comprises an exhaust-gas turbine in the exhaust duct and a compressor in the intake tract. Two turbine inlet flow passages of different size are provided in the housing of the exhaust-gas turbine, which turbine inlet flow passages open out in each case via a turbine inlet opening into the turbine space in which the turbine wheel is rotatably mounted. The turbine inlet flow passages are supplied via separate exhaust lines with the exhaust-gas of, in each case, one cylinder bank of the internal combustion engine. To adjust the exhaust-gas mass flows, a switching device is provided upstream of the exhaust gas turbine, which switching device is composed of two adjustable control valves, one of which valves is arranged in the exhaust line assigned to the relatively large exhaust-gas flow passage, and the second control valve is arranged in a line strand which connects the two exhaust lines. By means of the two control valves, either the relatively large turbine flow passage can be blocked, such that all of the exhaust gas flows into the relatively small turbine flow, or both exhaust-gas flows are acted on in the same way with equal exhaust-gas back pressure.

The relatively small turbine inlet flow passage is situated adjacent to the turbine rotor shaft bearing arrangement and to the shaft of the exhaust-gas turbine which rotationally fixedly couples the turbine wheel to the compressor wheel. Accordingly, the relatively large turbine inlet flow passage is situated at a greater distance from the shaft, which, on account of flow-related processes, brings about efficiency advantages in the relatively large turbine inlet flow passage which are effective in particular in the upper load and rotational speed range of the internal combustion engine. A recirculation line branches off the exhaust line which supplies the relatively small turbine inlet flow passage. The recirculation line is part of an exhaust-gas recirculation device, by means of which, for NOₓ reduction, a partial exhaust gas mass flow is re-circulated into the intake tract in the lower engine load and rotational speed range.

It is the principal object of the present invention to provide an exhaust-gas turbocharger in an internal combustion engine, in which, with simple design measures, the efficiency at low engine loads and rotational speeds is improved. In particular, in connection with an internal combustion engine which is fitted with an exhaust-gas recirculation device, a high exhaust-gas recirculation rate with high efficiency of the turbine is achieved by means of the exhaust-gas turbine.

### SUMMARY OF THE INVENTION

In an exhaust-gas turbocharger of an internal combustion engine including an exhaust-gas turbine coupled to a compressor by a shaft and having a relatively large and a relatively small turbine inlet flow passage, the relatively large turbine inlet flow passage is arranged adjacent to the shaft and the relatively small turbine inlet flow passage facing away from the shaft and a switching device is provided via which the exhaust gas of all the cylinders can be selectively supplied either to the small or to the large or to both of the turbine inlet flow passages. Furthermore, an exhaust gas recirculation line is in communication with the exhaust gas line section leading to the relatively small turbine inlet flow passage for re-circulating exhaust gas to the engine intake tract.

It is possible, by means of the switching device upstream of the turbine wheel, for the exhaust gas of all the cylinders to be selectively supplied either to the small or to the large turbine flow.

With the arrangement of the relatively small turbine inlet flow passage at a distance from the bearing arrangement or the shaft of the exhaust-gas turbocharger, favorable flow conditions with improved turbine efficiency prevail in the turbine inlet flow passage. Since it is possible by means of the upstream switching device to direct the exhaust gas flow of all the cylinders, in an advantageous switching position, to the relatively small turbine flow passage, it is possible to generate high exhaust-gas back pressures in the relatively small turbine flow and in the exhaust line which supplies said turbine flow with simultaneously good efficiency. As a result, it is possible to provide for exhaust-gas re-circulation also in the middle engine speed range and even at high engine loads. On account of the improved turbine efficiency, the turbine performance is simultaneously increased, such that also more air is fed by the compressor to the engine, which leads to an increase in the air ratio value λ and results in improved emissions behavior.

The advantage of the improved turbine efficiency in the relatively small turbine flow can duly be realized particularly expediently in an internal combustion engine with an exhaust-gas recirculation device, but is not restricted to this application. The high efficiency offers general advantages in wide operating ranges of the internal combustion engine. Performance increases are possible here, both in the powered drive operating mode and also in the engine braking mode.

The outer-contour-side turbine flow ensures that a relatively large gas mass flow proportion flows through the outer wheel blade region. The energy conversion into turbine power takes place here at relatively large radii of the blade, which leads to a relatively large deflection of the flow. The blade outlet of the radial turbine has a considerably smaller blade outlet angle (for example 28°) with respect to the peripheral direction in the outer region than in the hub region (for example 55°). A deflection is to be understood to mean the difference between the flow inlet angle and flow outlet angle (for example 90°-28° at the outside and 90°-55° at the inside). It has been found that said greater deflection angle at the larger radius leads to better energy conversion or to a higher turbine efficiency. The bearing-side turbine flow provides, in the turbine wheel, for a center line of the exhaust gas flow volume which lies closer to the wheel hub which results in a lower level of turbine efficiency.

The switching device can, in one advantageous embodiment, be moved into a switching position in which the exhaust gas of a first cylinder group can be supplied exclusively to the relatively small turbine inlet flow passage and the exhaust gas of a second cylinder group can be supplied exclusively to the relatively large turbine inlet flow passage. In this way, in a flow-related sense, a separation of the turbine flows including the respective exhaust lines is achieved. It is therefore possible to realize a plurality of different possible settings which are used depending on the momentary load and operating states of the internal combustion engine. For example, it is possible for the two inlet flow passages to be separated for realizing pulse induction in the middle to upper engine speed range. In the highest engine speed range, in contrast, it is possible for the purpose of ram induction for the inlet flows to be coupled in terms of flow by means of a corresponding setting of the switching device, such that the same exhaust-gas pressure prevails in both turbine inlet flow passages. At low engine speeds, it is however recommendable, to obtain high exhaust-gas recirculation rates with an excess of air, for the exhaust gas of all the cylinders of the internal combustion engine to be conducted to the small turbine inlet flow passage, whereas with increasing engine speeds, it is possible to direct the exhaust gas only to the relatively large turbine inlet flow passage, if appropriate, with the exhaust-gas recirculation being deactivated.

The volumes of the two turbine inlet flow passages conventionally differ significantly (though this is not imperative), for example, the volume ratio of the large turbine flow to the small turbine flow may lie in a value range between 1.5 and 5, with all values in between also coming into consideration. With this size difference, different pressure ratios are set in the turbine flows depending on whether the exhaust gas is supplied entirely to the relatively large or relatively small turbine inlet flow passage, which can be particularly advantageously utilized for improved exhaust-gas recirculation. A higher exhaust-gas back pressure can be realized in the relatively small turbine inlet flow passage because its volume is smaller than that of the relatively large turbine inlet flow passage.

The exhaust-gas turbine is expediently a radial flow turbine with a turbine wheel to which the exhaust gas flow is admitted radially and both, the relatively large and also the relatively small turbine inlet flow passages being positioned radially upstream. The two turbine inlet flow passages are joined at the turbine inlet opening, that is, at the entrance to the turbine wheel space in which the turbine wheel is rotatably supported. According to a first advantageous embodiment, the two turbine flows have a common turbine inlet opening to the turbine wheel space. According to a second embodiment, the turbine inlet openings of the two turbine inlet flow passages are divided by a partition which separates the inlet flow passages, which prevents a mixture of the exhaust gas flow upstream of the turbine wheel.

The exhaust-gas turbine is expediently fitted with a variable turbine geometry, by means of which the effective turbine inlet opening—either the turbine inlet opening of the relatively large turbine inlet flow passage or of the relatively small turbine inlet flow passage or of both turbine inlet flow passages—can be controlled as a function of momentary state and operating variables. The variable turbine geometry may be, for example, an axial slide which can be moved axially into, and out of, the turbine inlet flow passages. As an alternative to this, it is possible for the variable turbine geometry to comprise a guide vane structure with adjustable guide vanes which is arranged in the turbine inlet flow passages. By means of adjustment of the variable turbine geometry, it is possible in particular to adjust the exhaust-gas back pressure both in the engine drive operating mode and also in the engine braking mode.

In one preferred embodiment, the switching device includes, in a switching housing, a blocking flap which is pivotable about a rotational axis and which has two vanes, of at least approximately equal length, at both sides of the rotational axis, with the blocking flap being mounted in a connecting space within the switching housing, which connecting space is connected both to the two turbine inlet flow passages and also to the two exhaust lines extending in each case from one cylinder group. Depending on the rotational position of the blocking flap, the two exhaust lines and turbine inlet flow passages are separated from one another in terms of flow, and all of the exhaust gas is conducted either to the relatively small or to the relatively large turbine inlet flow passage or both turbine inlet flow passages are subjected to the same exhaust-gas pressure. Because of the design of the blocking flap with equally long flap vanes on both sides of the rotational axis, gas force compensation is obtained since both vanes of the blocking flap are subjected to the same pressure force, such that no resultant torque about the rotational axis of the blocking flap can be generated. Even in the event of pressure pulsations in the exhaust strand, uniform force loading without a resultant torque is obtained, such that the blocking flap is always in equilibrium and its momentary position is always maintained.

The invention will become more readily apparent from the following description thereof on the basis of the accompanying drawings:

### BRIEF DESCRIPTION OF THE DRAWINGS

FIG. 1 is a schematic illustration of an internal combustion engine with an exhaust-gas turbocharger whose exhaust-gas turbine is in the form of a doubleflow turbine with a relatively large and relatively small turbine inlet flow passage supplied with the exhaust gas of different cylinder banks of the internal combustion engine, the exhaust-gas mass flows being controlled by means of a switching device which is positioned upstream of the turbine inlet flow passages, and

FIG. 2 shows an engine-torque/engine-speed diagram with different characteristic curves which represent different switching states of the switching device.

### DESCRIPTION OF A PARTICULAR EMBODIMENT OF THE INVENTION

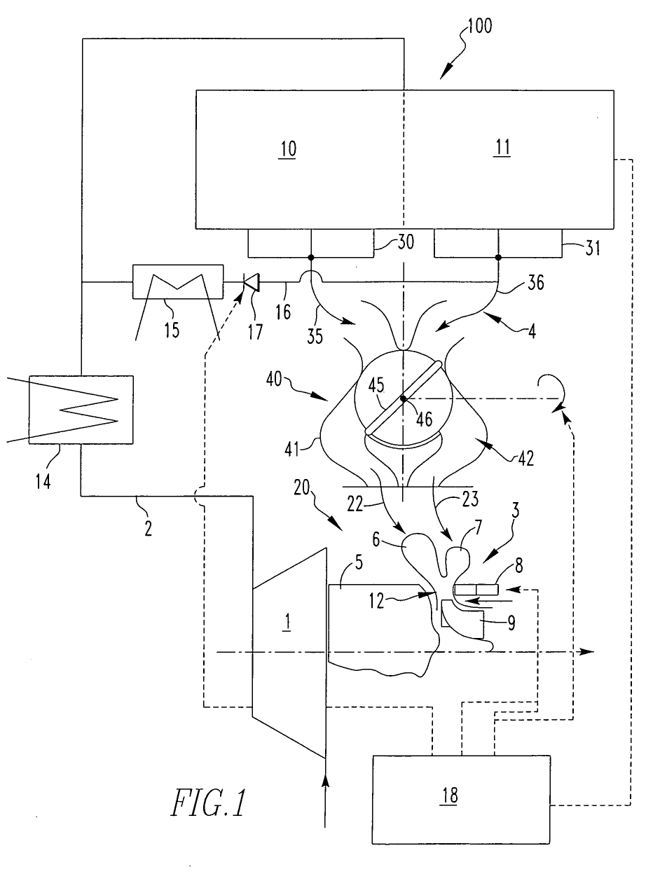

The internal combustion engine 100 which is illustrated in FIG. 1—a spark-ignition engine or a diesel engine—has two cylinder banks 10 and 11 which comprise in each case one group of cylinders.

The exhaust gas of each cylinder bank 10 and 11 is conducted by way of associated exhaust manifolds 30 and 31 into the exhaust strand 4, which comprises line sections 35 and 36 which are connected to the exhaust manifolds 30 and 31 and which open out into a switching device 40. The switching device 40 is connected, downstream of the internal combustion engine, by means of further exhaust line sections 22 and 23 to an exhaust-gas turbine 3 which is part of an exhaust-gas turbocharger 20.

The exhaust-gas turbine 3 includes a turbine wheel 9 which is driven by the pressurized exhaust gases of the internal combustion engine, with the rotational movement of the turbine wheel 9 being transmitted by means of a shaft 5 to a compressor wheel in the compressor 1 of the exhaust-gas turbocharger 20. The compressor wheel sucks in combustion air from the environment and compresses said air to an increased charge pressure at which it is supplied to the engine cylinders. Downstream of the exhaust-gas turbine 3, the expanded exhaust gas is subjected to purification, and is subsequently discharged. If appropriate, a bypass with an adjustable bypass valve is provided for bypassing the exhaust-gas turbine 3.

At the air side, the combustion air which is compressed in the compressor 1 is conducted into the intake tract 2 and is cooled in a charge-air cooler 14 which is positioned downstream of the compressor 1. The charge air is subsequently supplied under charge pressure to the cylinder inlets of the internal combustion engine 100.

The internal combustion engine 100 is also provided with an exhaust-gas recirculation device which comprises a recirculation line 16 extending between the exhaust line section 36 of the cylinder bank 11 upstream of the switching device 40 and the intake tract 2 downstream of the charge-air cooler 14. An adjustable, unidirectional recirculation valve 17 and an exhaust-gas cooler 15 are arranged in the recirculation line 16.

The exhaust-gas turbine 3 is a twin-flow turbine and comprises, in the turbine housing, two exhaust-gas or turbine inlet flow passages 6 and 7 which are of different size and which are connected in each case to an exhaust line 22 and 23. The two turbine inlet flow passages 6 and 7 have significantly different volumes with the volume ratio between the relatively large and the relatively small turbine inlet flow passage being for example in a value range between 1.5 and 5. The relatively large turbine inlet flow passage 6 is arranged directly adjacent to the bearing arrangement or to the shaft 5 of the exhaust-gas turbocharger 20, while, in contrast, the relatively small turbine inlet flow passage 7 is arranged on the side which is more remote from the shaft 5 and is correspondingly at a greater distance from the shaft 5 than the relatively large turbine inlet flow passage 6. Particularly favorable flow conditions with a high turbine efficiency prevail in the relatively small turbine inlet flow passage 7. The relatively large turbine inlet flow passage 6 is supplied with the exhaust gases of the first cylinder bank 10 via the exhaust line sections 35 and 22. The relatively small turbine inlet flow passage 7 is supplied with the exhaust gases of the second cylinder bank 11 via the exhaust line sections 36 and 23. The exhaust lines for the relatively large and the relatively small turbine inlet flow passages are basically separate from one another.

The switching device 40 which is arranged in the flow path of the exhaust lines and is preferably integrated into the turbine housing has, in its switching housing structure 41, inlet ducts for the exhaust line sections 35 and 36 and outlet ducts for the exhaust line sections 22 and 23. The inlet ducts and the outlet ducts open out in each case into a connecting space 42 in the switching housing 41, in which connecting space 42 a blocking flap 45 is mounted so as to be pivotable about a rotational axis 46. The blocking flap 46 may assume different angular positions, a first position in which all of the exhaust gas of the first cylinder bank 10 and also of the second cylinder bank 11 is conducted into the relatively large turbine flow 6 in a first position. In a second position, all of the exhaust gas of both cylinder banks 10 and 11 is conducted into the relatively small turbine flow 7. In a third position of the blocking flap 45, the exhaust lines are completely separated such that the exhaust gas from the first cylinder bank 10 is conducted exclusively to the relatively large turbine flow and the exhaust gas from the second cylinder bank 11 is conducted exclusively to the relatively small turbine flow 7. Finally, in a fourth angular position of the blocking flap 45, a mixture of the exhaust gas takes place, in that the exhaust gas from both cylinder banks is supplied in the same way and under the same exhaust-gas pressure to the two turbine inlet flow passages 6 and 7.

The exhaust-gas turbine 3 is fitted with a variable turbine geometry 8 which, in the exemplary embodiment, is an axial slide which can be inserted into the turbine inlet opening 12 in the direction as illustrated by the arrow in order to variably adjust the effective cross-flow section. As an alternative to an axial slide, it is also possible to use a guide vane structure with guide vanes which can be adjusted for controlling the inlet flow to the turbine.

The exhaust-gas turbine 3 is preferably a radial flow turbine, and accordingly, the turbine inlet opening 12 is positioned radially upstream of the turbine wheel 9. The turbine inlet flow passages 6 and 7 have a common turbine inlet opening 12. It may however also be expedient for each turbine inlet flow passage 6 and 7 to have turbine inlet openings separated by a partition.

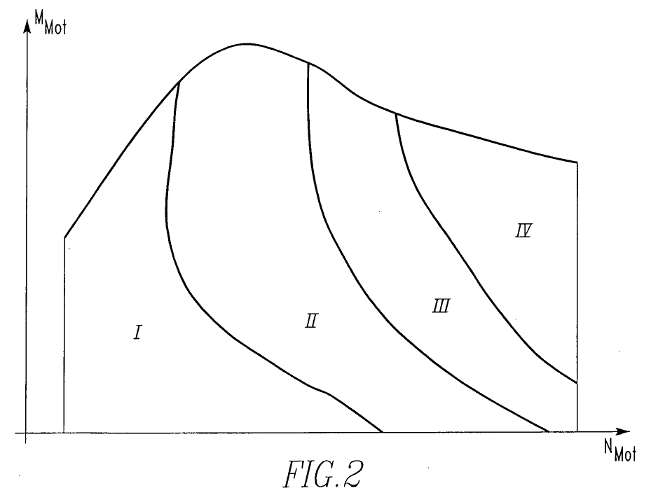

FIG. 2 shows a diagram representing the engine torque M_{Mot} plotted over the engine speed n_{Mot}. Plotted in the diagram are various characteristic curves which represent different switching positions of the switching device 40 of FIG. 1. The characteristic curves divide the profile of the engine torque M_{Mot} into various regions which are assigned to different engine operating states. In a first region I which is assigned to low engine speeds, exhaust-gas recirculation takes place with an excess of air (λ>1). In said region I, all of the exhaust gas of the internal combustion engine, that is to say the exhaust gas from the cylinder bank 10 and also from the cylinder bank 11, is supplied exclusively to the relatively small turbine inlet flow passage 7 by means of a corresponding setting of the switching device 40. In this way, the exhaust-gas back pressure in the relatively small turbine inlet flow passage 7 increases strongly, which permits exhaust-gas recirculation up to middle ranges of the engine speed.

In the second region II, which directly adjoins the region I and which extends into a middle to higher rotational speed range and up to the maximum engine torque M_{Mot}, exhaust gas of both cylinder banks 10 and 11 is supplied only to the relatively large turbine inlet flow passage 6.

In the third region III, which is assigned to the highest engine speeds, the two turbine flows are expediently separated from one another. Pulse induction takes place in this region.

The final region IV is characterized by a flow comprising a mixture of exhaust gas in the two exhaust lines or turbine inlet flow passages, such that, in principle, the same exhaust-gas back pressure prevails in both turbine inlet flow passages. Ram induction takes place in this region. This is obtained in the switching device 40 by means of an intermediate flap position of the blocking flap 45.

What is claimed is:

1. An exhaust-gas turbocharger in an internal combustion engine having at least two groups (11, 12) of cylinders including exhaust gas strands (4) with different sections (35, 36), the turbocharger having an exhaust-gas turbine (3) with a turbine wheel in the exhaust strand (4) of the internal combustion engine and having a compressor (1) in the intake tract (2), the turbine wheel (9) of the exhaust-gas turbine (3) being rotationally coupled by means of a shaft (5) to the compressor wheel of the compressor (1), the exhaust-gas turbine (3) having two separate turbine inlet flow passages (6, 7) of different volume for supplying exhaust gas to the turbine wheel (9), and a switching device (46) arranged in the exhaust strand (4) for controlling the exhaust gas mass flow through the two turbine inlet flow passages (6, 7), so that, selectively, the exhaust gas of one or more cylinder groups can be supplied selectively to one or both of the turbine flow passages (6, 7), the relatively large turbine flow passage (6) of the exhaust-gas turbine (3) being arranged adjacent to the shaft (5) and the relatively small turbine inlet flow passage (7) being arranged remote from the shaft (5).

2. The exhaust-gas turbocharger as claimed in claim 1, wherein the switching device (40) is movable into a switching position in which the exhaust gas of a first cylinder group (11) is supplied exclusively to the relatively small turbine inlet flow passage (7) and the exhaust gas of a second cylinder group (10) is supplied exclusively to the relatively large turbine inlet flow passage (6).

3. The exhaust-gas turbocharger as claimed in claim 1, wherein the exhaust-gas turbine (3) is a radial flow turbine with a turbine wheel (9) which is approached by a radial flow, with the two turbine inlet flow passages (6, 7) being in communication with the turbine wheel (9) by means of a turbine inlet flow opening (12) which is positioned radially upstream of the turbine rotor (9).

4. The exhaust-gas turbocharger as claimed in claim 3, wherein the two turbine inlet flow passages (6, 7) have a common turbine inlet flow opening (12) to the turbine wheel (9).

5. The exhaust-gas turbocharger as claimed in claim 1, wherein the exhaust-gas turbine (3) is fitted with a variable turbine geometry (8) for the variable adjustment of the effective flow cross-section of the turbine inlet flow opening (12).

6. The exhaust-gas turbocharger as claimed in claim 5, wherein the variable turbine geometry (8) comprises an axial slide member which is movable into the turbine inlet opening (12).

7. The exhaust-gas turbocharger as claimed in claim 1, wherein the switching device (40) is integrated into the turbine housing of the exhaust-gas turbine (3).

8. The exhaust-gas turbocharger as claimed in claim 1, wherein the switching device (40) in a switching housing (41) comprises a blocking flap (45) which is pivotable about a rotational axis (46) and which has two vanes, of at least approximately equal length, at opposite sides of the rotational axis (46), with the blocking flap (45) being mounted in a connecting space (42) in the switching housing (41), and with the connecting space (42) being connected both to the two turbine inlet flow passages (6, 7) of the exhaust-gas turbine (3) and also to two exhaust lines (22, 23) which are assigned each to one cylinder group (10, 11) of the internal combustion engine (100).

9. An internal combustion engine having an exhaust-gas turbocharger as claimed in claim 1, wherein an exhaust gas recirculation device is provided which connects an exhaust line section (36) leading to the relatively small turbine inlet flow passage (7) with the intake tract (2).
